(19) United States
(12) Patent Application Publication
(10) Pub. No.: US 2009/0245810 A1
(43) Pub. Date: Oct. 1, 2009

(54) Dynamic Signal Equalization in Optical Transmission Systems

(75) Inventors: Yue-Kai Huang, Princeton, NJ (US); Ting Wang, Princeton, NJ (US); Lei Xu, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/054,763

(22) Filed: Mar. 25, 2008

(51) Int. Cl. H04B 10/04; H04B 10/12

(52) U.S. Cl. 398/182

(57) ABSTRACT

In an optical transmission system, data is transmitted via an optical beam modulated with an arbitrary waveform. The optical beam is transmitted through at least one optical element. Transmission through at least one optical element degrades the signal quality of the initial optical beam. The signal characteristics of at least one optical beam at the output of least one optical element are used as feedback to shape the arbitrary waveform to improve signal characteristics. An arbitrary waveform may be used to compensate signal degradation caused by a multiplexer/demultiplexer in a wavelength division multiplex system.

### BACKGROUND OF THE INVENTION

The present invention relates generally to fiber optic transmission systems, and more particularly to dynamic signal equalization in wavelength division multiplexed systems.

Fiber optic telecommunications has been a well-established, reliable technology for high-speed data transport in core packet data networks. More recently, fiber optics has been deployed in access networks, including links all the way to the customer premises. As the demand for multimedia services (data, voice, video) transported over packet data networks continues to grow, requirements for higher network throughput correspondingly continues to grow. One technique for increasing the throughput of a fiber optic network is wavelength division multiplexing (WDM). In this technique, multiple optical data channels are transported over a single fiber. Each data channel is carried over a well-defined wavelength of light.

On the transmitter side of a fiber optic link, there is an array of optical sources, with each source emitting an optical beam at a different characteristic wavelength. Each individual optical beam is transmitted into a separate input port of a wavelength division multiplexer (MUX), which spatially combines the array of optical beams into a single multi-wavelength optical beam. The combined multi-wavelength optical beam is then launched from the output port of the MUX into an optical fiber. On the receiver side of a fiber optic link, the combined multi-wavelength optical beam is transmitted into the input port of a wavelength division demultiplexer (DEMUX), which spatially separates the individual optical beams according to their characteristic wavelengths. Each individual optical beam is transmitted to a separate output port to which an individual optical detector is connected. The data throughput of a fiber optic link increases with the number of wavelengths which are multiplexed.

To minimize signal crosstalk and noise propagation, optical filters are applied to each wavelength channel at a MUX or DEMUX. Because of physical limitations on design parameters, these filters have a non-uniform transfer function, resulting in signal degradation. What are needed are method and apparatus to improve the signal quality of optical signals transmitted through a wavelength division multiplex system.

### BRIEF SUMMARY OF THE INVENTION

Data is transmitted through an optical network by modulating an optical beam with an arbitrary waveform based at least in part on a data bit stream. The arbitrary waveform is a user-defined arbitrary waveform, not necessarily defined by telecommunications standards. The signal characteristics of the arbitrary waveform may be varied to compensate for signal degradation caused an optical beam passing through an optical element, such as a wavelength multiplexer/demultiplexer used in a wavelength division multiplex system. A dynamic feedback control signal generated by an optical element may be used to define the arbitrary waveform.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a wavelength division multiplex optical transmission system;

FIG. 2(a) shows a high-level schematic of an optical source with a direct modulated laser;

FIG. 2(b) shows a high-level schematic of an optical source with an external intensity modulator;

FIG. 3(a) shows a plot of measured transmittance as a function of wavelength for a multiplexer/demultiplexer;

FIG. 3(b) shows a plot of a simulated profile of intensity as a function of frequency for an arbitrary waveform;

FIG. 4 shows a high-level schematic of an optical transmission network;

FIG. 5(a) shows simulated eye diagrams of optical signals transmitted through an optical transmission network;

FIG. 5(b) shows simulated eye diagrams of optical signals transmitted through an optical transmission network including an arbitrary waveform generator;

FIG. 6 shows a high-level schematic of an optical transmission network including an arbitrary waveform generator;

FIG. 7 shows a flowchart of steps for feedback control; and,

FIG. 8 shows a high-level schematic of a computer which may be used as a programming unit for an arbitrary waveform generator.

### DETAILED DESCRIPTION

In wavelength division multiplex (WDM) optical transmission systems, multiple optical carriers with different wavelengths are simultaneously transmitted over a single optical fiber. Data is transmitted over an optical carrier by modulating the optical carrier. Various modulation schemes may be used; for example, amplitude modulation, frequency modulation, and phase modulation. The optical carriers, herein also referred to as optical channels, are characterized by their channel center wavelengths, channel widths, and inter-channel spacings. Optical parameters may also be specified in terms of the frequencies corresponding to the wavelengths. Some current generation dense wavelength division multiplex (DWDM) systems may simultaneously transmit 128 optical channels, each with a channel width of 50 GHz. Data rates of 40 Gbit/sec may be transmitted over each optical channel. Next generation DWDM systems are being developed to accommodate even more channels with even higher data rates per channel.

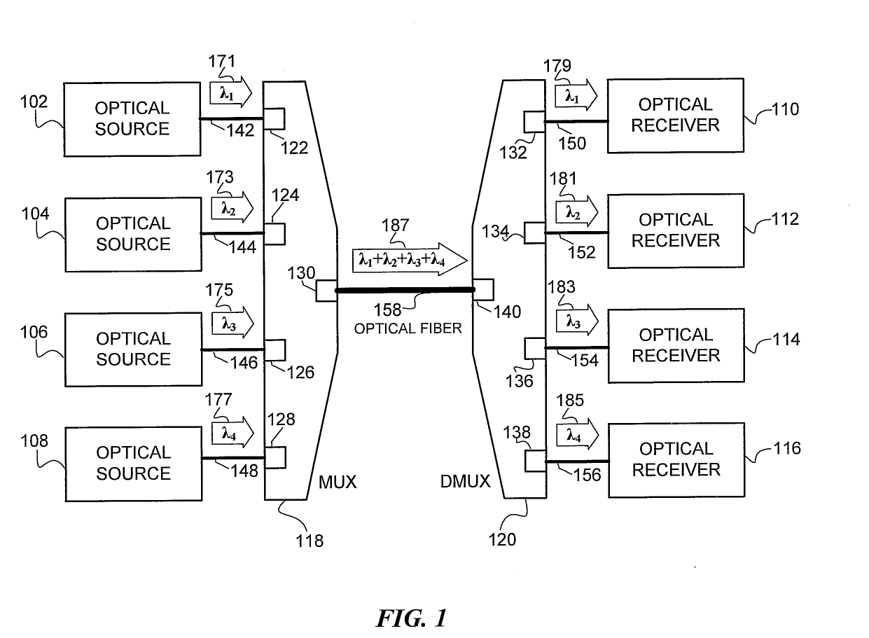

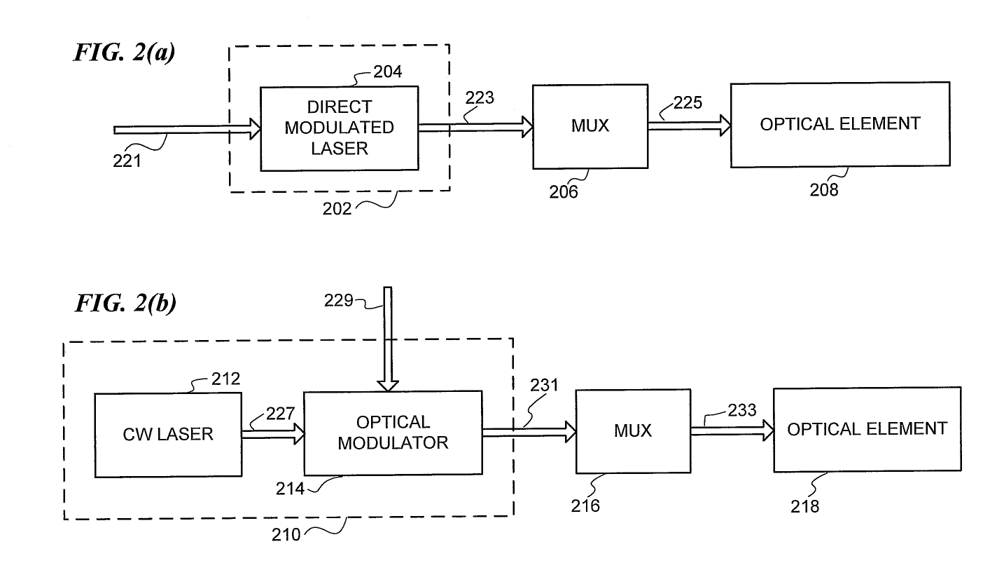

FIG. 1 shows a high-level schematic of an example of a WDM optical transmission system with four wavelengths. Optical sources 102-108 emit separate optical beams 171-177, each with a different wavelength λ₁-λ₄, respectively. Examples of optical sources are discussed below, with reference to FIG. 2(a) and FIG. 2(b). Optical sources 102-108 couple to input ports 122-128 of wavelength division multiplexer (MUX) 118 via optical connections 142-148, respectively. Optical connections 142-148 may, for example, be optical fibers. MUX 118 multiplexes optical beams 171-177 into combined optical beam 187, which is transmitted from output port 130 of MUX 118 across optical fiber 158 to input port 140 of wavelength division demultiplexer (DEMUX) 120. DEMUX 120 demultiplexes combined optical beam 187 into separate optical beams 179-185, with wavelengths λ₁-λ₄, respectively. Optical beams 179-185 are emitted from output ports 132-138 to optical receivers 110-116 via optical connections 150-156, respectively. For simplicity, in FIG. 1, MUX 118 and DEMUX 120 are directly connected by optical fiber 158. In general, MUX 118 and DEMUX 120 may be connected by an optical transmission network, in which optical beam 187 may be transmitted through additional optical and optoelectronic components. Herein, any component within the transmission path between the originating optical source and destination optical receiver is referred to as an optical element. Optical elements include, for example, mux/demux's, optical splitters, optical circulators, fiber amplifiers, and optical fiber. Herein, an optical element also refers to an optoelectronic device, such as an optoelectronic transceiver, within the transmission path.

FIG. 2(a) and FIG. 2(b) show high-level schematics of examples of systems for transmitting modulated optical beams. Modulated optical source 202 and modulated optical source 210 are examples of optical sources 102-108 in FIG. 1. For simplicity, physical connections are not shown in FIG. 2(a) and FIG. 2(b),and the hollow arrows represent electrical or optical signals. In FIG. 2(a), modulated optical source 202 is direct modulated laser 204. Electrical drive signal 221 drives direct modulated laser 204, which emits single-wavelength laser beam 223. Modulation of electrical drive signal 221 controls modulation of laser beam 223, which is inputted into MUX 206. The corresponding output laser beam 225 is then transmitted to optical element 208.

In FIG. 2(b), modulated optical source 210 comprises continuous-wave (CW) laser 212 and external optical modulator 214. An example of optical modulator 214 is a lithium niobate optical intensity modulator. CW laser 212 emits single-wavelength laser beam 227, which is maintained at a constant intensity. Laser beam 227 is then transmitted through optical modulator 214. For amplitude modulation, electrical drive signal 229 modulates the transmittance of optical modulator 214. The output of optical modulator 214 is modulated laser beam 231, which is then inputted into MUX 216. The corresponding output laser beam 233 is then transmitted to optical element 218.

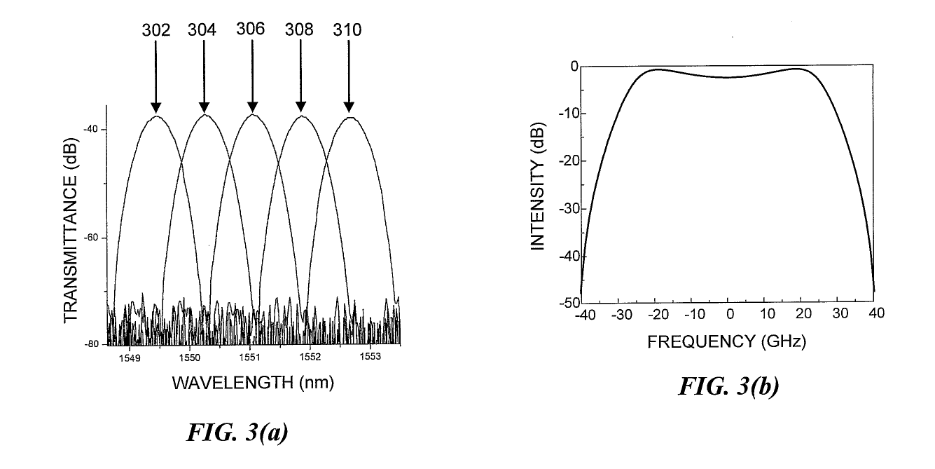

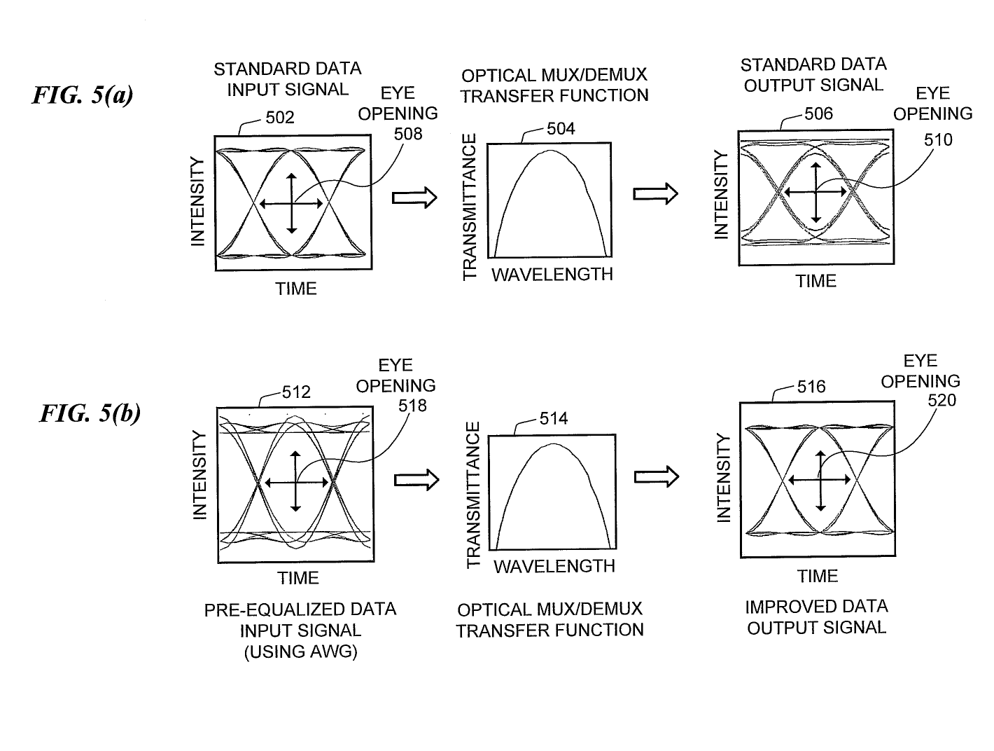

To minimize noise generation by an optical carrier and to minimize cross-talk between optical channels, each optical carrier is filtered when it is transmitted through a MUX/DEMUX. For example, ITU standards (ITU-T G.694.1) define DWDM systems with inter-channel spacings of 12.5 GHz to 100 GHz. FIG. 3(a) shows a plot of the measured transmittance of an arrayed waveguide MUX as a function of wavelength. Superimposed measurements are shown for five channels with center wavelengths 302-310. The transmittance of a channel is highest near the center wavelength of the channel and drops off at the boundaries (lowest and highest wavelengths) of the channel. For improved signal characteristics, it is desirable for the transmittance to be constant over the width of the channel. The functional dependence of transmittance on wavelength, as shown in FIG. 3(a), creates higher losses for high (signal) frequency components in a modulated signal, resulting in degraded signal rise and fall times. Signal quality is discussed further below with reference to FIG. 5(a) and FIG. 5(b).

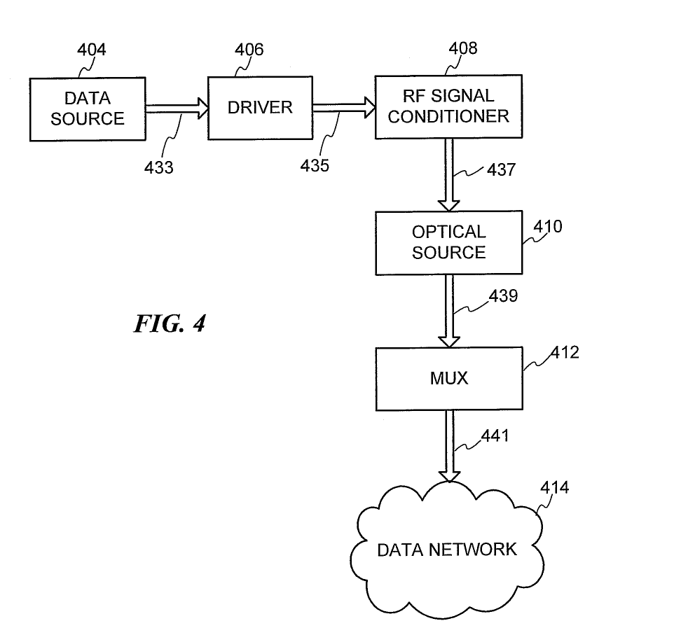

FIG. 4 shows a more detailed view of a portion of a standard optical network. In general, there is an array of optical sources, each emitting at a different wavelength, as discussed above with reference to FIG. 1. For simplicity, only a single optical source emitting at a single wavelength is shown. Physical connections are not shown in the figure, and the hollow arrows represent electrical or optical signals. Data source 404 transmits a data bit stream via electrical signal 433 to driver 406. Examples of data source 404 are personal computers, workstations, servers, switches, and routers. Driver 406 converts electrical signal 433 to modulated RF signal 435 which is then transmitted through RF signal conditioner 408, which, for example, is a set of passive RF components. RF signal conditioner 408 performs signal conditioning such as filtering and pre-equalization, for example. The output of RF signal conditioner 408 is RF signal 437, which is the input RF drive signal to optical source 410. RF drive signal 437 corresponds, for example, to electrical drive signal 221 in FIG. 2(a) and electrical drive signal 229 in FIG. 2(b). Optical signal 439 is then transmitted from optical source 410 to MUX 412. Optical signal 441 is outputted from MUX 441 to data network 414.

FIG. 5(a) shows degradation of signal quality when optical signal 439 passes through MUX 412. Values shown in FIG. 5(a) are simulated values. Plot 502 shows an eye diagram (optical intensity as a function of time) of a standard data input signal (for example, on/off key modulation) carried on optical signal 439 in FIG. 4. For standard optical transmission systems, such as a SONET OC-768, the waveform of RF signal 437 has defined signal characteristics in terms of signal rise-time, overshoot, and other dynamic signal characteristics. The waveform is a raised cosine, modulated in a non-return-to-zero (NRZ) format. As seen in plot 502, the corresponding optical signal 439 has a clean, wide eye opening 508. Plot 504 shows the transfer function (transmittance as a function of wavelength) for an arrayed waveguide MUX 412. As discussed earlier with respect to FIG. 3(a), the transmittance is higher at the center of the optical channel and rolls off at the boundaries of the channel. This non-ideal transfer function leads to signal degradation. Plot 506 shows the eye diagram of the optical signal 441 at the output of MUX 412. The eye opening 510 is noisier and less open than eye opening 508. Note that similar signal degradation occurs when an optical signal passes through a DEMUX, causing further degradation.

Instead of the standard data input waveform, the input waveform may be modified to compensate for the signal degradation caused by the MUX/DEMUX. In an advantageous embodiment, an arbitrary waveform generator (AWG) is used to compensate for a wide range of signal degradation. An arbitrary waveform generator generates an arbitrary waveform. Herein, an arbitrary waveform refers to a waveform defined by a user, and not necessarily by standards. In general, an arbitrary waveform may be used to compensate for signal degradation caused by optical elements along the transmission path, not just signal degradation caused by a MUX/DEMUX. In the examples below, signal degradation caused by a MUX/DEMUX is used to illustrate an embodiment of the invention. One skilled in the art may develop embodiments to compensate for other sources of signal degradation. One skilled in the art may also develop embodiments to compensate for signal degradation in communications system using transmission media other than optical fiber, such as twisted-pair cable, coaxial cable, wireless RF, microwave, and free-space optics.

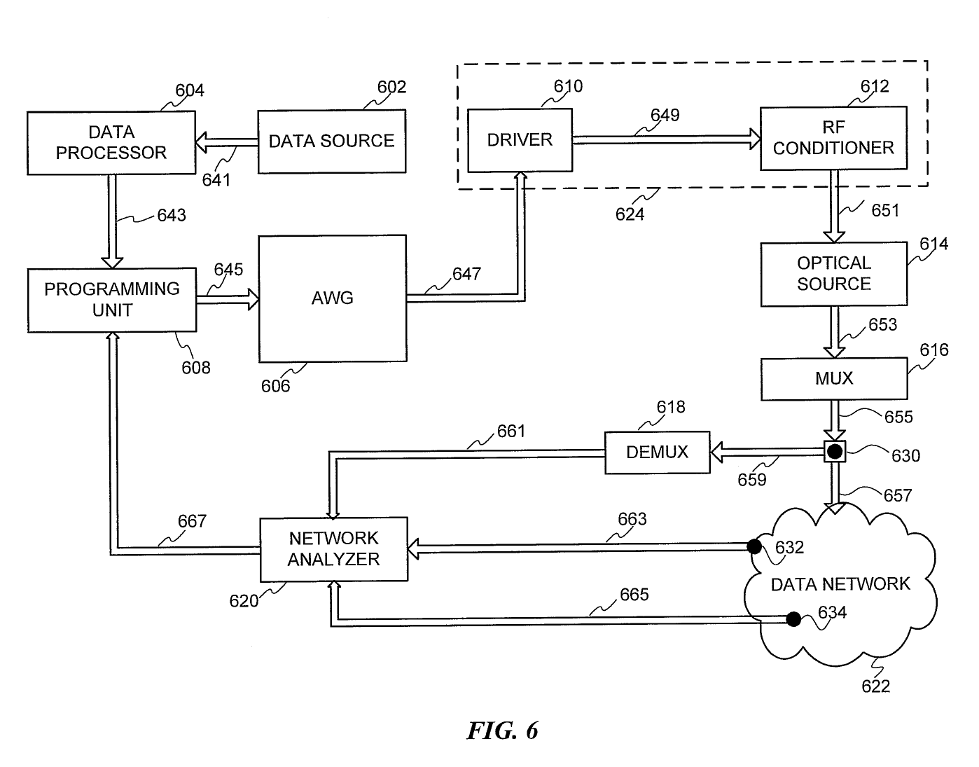

FIG. 6 shows a high-level schematic of an optical transmission network according to an embodiment of the invention. In general, there is an array of optical sources, each emitting at a different wavelength, as discussed above with reference to FIG. 1. For simplicity, only a single optical source emitting at a single wavelength is shown. Physical connections are not shown in the figure, and the hollow arrows represent electrical or optical signals. Data source 602 transmits a data bit stream via electrical signal 641 to data processor 604, which converts electrical signal 641 to electrical signal 643, which is compatible with the input interface to programming unit 608. Programming unit 608 controls operation of AWG 606 by transmitting AWG control instructions to AWG 606 via electrical signal 645. The output of AWG 606 is RF signal 647, which is transmitted to the input of driver 610. RF signal 649 is transmitted from the output of driver 610 to the input of RF conditioner 612. The output of RF conditioner 612 is RF signal 651, which is the input RF drive signal to optical source 616. Herein, RF driver module 624 comprises driver 610 and RF conditioner 612. Optical signal 653 is outputted from optical source 614.

Optical signal 655 at the output of MUX 616 may be measured by an optical analyzer (not shown in FIG. 6), and RF signal 647 may be modified by AWG 606, under the control of programming unit 608, to improve signal characteristics relative to the signal characteristics of optical signal 441 in FIG. 4. FIG. 3(b) shows the spectral shape of optical signal 653 generated by AWG 606 (via driver 610 and RF conditioner 612). In this plot, frequency=0 is the relative frequency corresponding to the center wavelength of the channel. Note the reduced intensity at the center frequency to compensate for the increased transmittance of the MUX at the center of the channel, as shown in FIG. 3(a). The resulting eye diagrams are shown in FIG. 5(b). Plot 512 shows the data input signal carried on optical signal 653 in FIG. 6. Note that eye opening 518 is not as clean and open as eye opening 508 for a standard data input signal. Plot 514 (identical to plot 504) shows the transfer function for arrayed waveguide MUX 616. Plot 516 shows the eye diagram for optical signal 655 at the output of MUX 616. Note that the eye opening 520 is cleaner and more open than eye opening 510.

In some applications, it may be adequate for the settings of programming unit 608 to be quasi-static once the desired signal characteristics of optical signal 655 have been achieved. For example, the signal characteristics of optical signal 655 may be measured with an optical analyzer at periodic maintenance intervals. The output waveform on RF signal 647 may then be re-shaped if necessary to maintain the desired signal characteristics, since the signal characteristics of optical elements may change over time.

In other applications, dynamic feedback control signals may be tapped from various nodes in the transmission path. In the example shown in FIG. 6, optical signal 655 is input to optical splitter 630. Optical signal 657 continues to data network 622. Optical signal 659 is input to DEMUX 618. The output of DEMUX 618 is optical signal 661, which is provided as an optical feedback control signal to network analyzer 620, which includes a signal analyzer for electrical and optical signals. As another example, optical signal 663 is a dynamic optical feedback control signal tapped from edge node 632. As a further example, electrical signal 665 is a dynamic electrical feedback control signal tapped from intermediate node 634. For example, electrical signal 665 may be generated at the electrical output interface of an optoelectronic receiver. Herein, a dynamic feedback control signal refers to optical feedback control signals or electrical feedback control signals. In general, network analyzer 620 may have multiple optical and electrical input ports.

Network analyzer 620 analyzes the dynamic feedback control signals (optical signal 661, optical signal 663, and electrical signal 665), and outputs signal analysis data via electrical signal 667 to programming unit 608. The signal analysis data reports the signal characteristics of the dynamic feedback control signals. Using the input from network analyzer 620, programming unit 608 modifies RF signal 647 generated by AWG 606. Network analyzer 620, programming unit 608, and AWG 606 may be implemented by various combinations of hardware and software. For example, they may be integrated into a single unit. Other embodiments may use different transmission media for connections. For example, the connection between network analyzer 620 and programming unit 608 may be a fiber optic link. As another example, the connection between programming unit 608 and AWG 606 may be a wireless RF link.

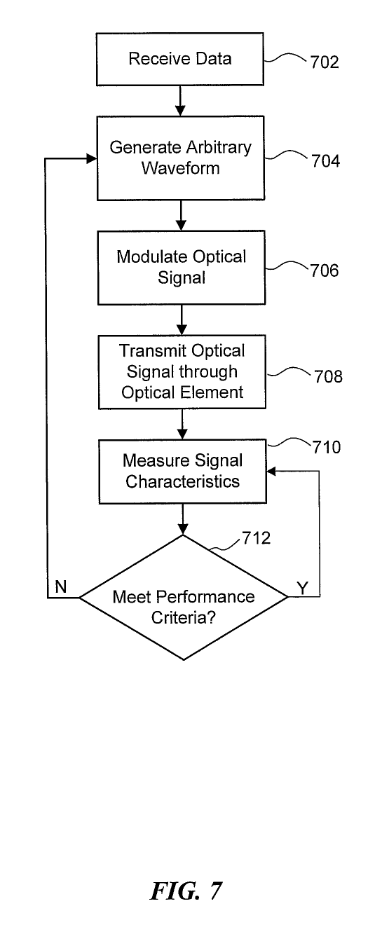

FIG. 7 shows a flowchart of steps for dynamic monitoring and maintenance of signal characteristics (also referred to as signal quality), in reference to the optical transmission network shown in FIG. 6. In step 702, an input data bit stream is received by programming unit 608 from data source 602 via electrical signal 641, data processor 604, and electrical signal 643. In step 704, in response to the input data bit stream, programming unit 608 sends control instructions via electrical signal 645 to AWG 606. AWG 606 then generates an arbitrary waveform, which is transmitted on RF signal 647. RF signal 647 is then further processed by driver 610 and RF conditioner 612 to generate RF signal 651. In step 706, RF signal 651 drives optical source 614 to modulate optical signal 653. In step 708, optical signal 653 is transmitted through optical element MUX 616.

In step 710, the signal characteristics of optical signal 655 at the output of MUX 616 are measured. Optical signal 659 is split from optical signal 655 via optical splitter 630. Optical signal 659 is then transmitted through DEMUX 618. The output of DEMUX 618 is optical signal 661, which is transmitted to network analyzer 620. Network analyzer 620 measures the signal characteristics of optical signal 661 and reports the measurements to programming unit 608 via electrical signal 667. In step 712, the measured signal characteristics of optical signal 661 are compared with user-defined performance criteria stored in programming unit 608. If the signal characteristics of optical signal 661 meet the user-defined performance criteria, then the process returns to step 710, in which the signal characteristics of optical signal 655 are measured again. Step 710 and step 712 are constantly iterated to maintain dynamic monitoring of signal quality. In step 712, if the measured signal characteristics of optical signal 661 do not meet the user-defined performance criteria, then the process returns to step 704, in which a new arbitrary waveform is generated. Step 704-step 712 are then iterated. One skilled in the art may develop other embodiments for dynamically monitoring and controlling the signal quality in the optical transmission network. For example, as discussed above with respect to FIG. 6, dynamic feedback control signals may be tapped from other nodes such as node 632 and node 634. Dynamic feedback control signals may be used in combination.

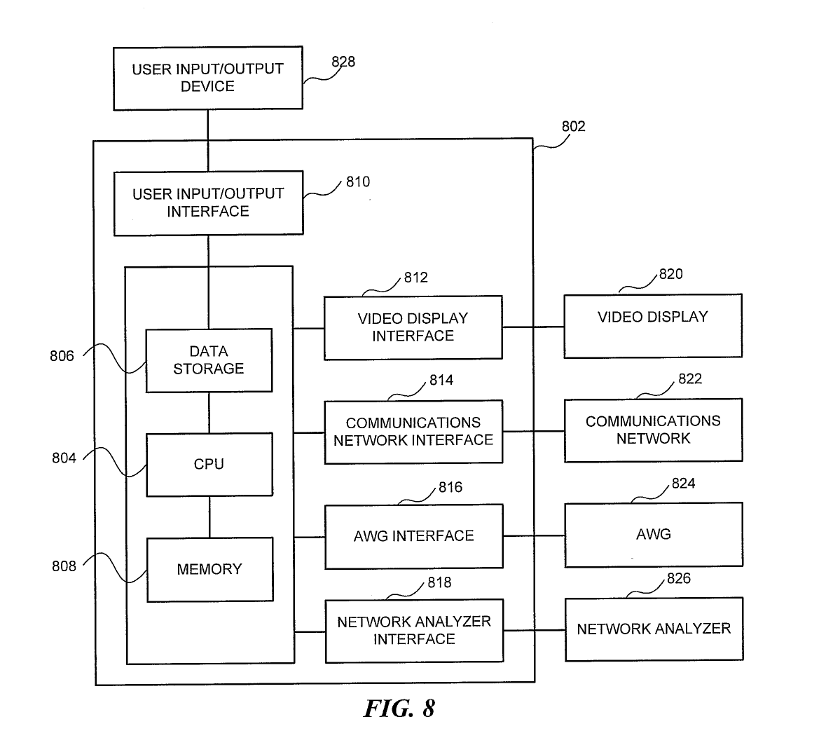

One embodiment of programming unit 608 in FIG. 6 may be implemented using a computer. As shown in FIG. 8, computer 802 may be any type of well-known computer comprising a central processing unit (CPU) 804, memory 808, data storage 806, and user input/output interface 810. Data storage 806 may comprise a hard drive or non-volatile memory. User input/output interface 810 may comprise a connection to a user input device 828, such as a keyboard or mouse. As is well known, a computer operates under control of computer software which defines the overall operation of the computer and applications. CPU 804 controls the overall operation of the computer and applications by executing computer program instructions which define the overall operation and applications. The computer program instructions may be stored in data storage 806 and loaded into memory 808 when execution of the program instructions is desired. Computer 802 may further comprise a video display interface 812, which may transform signals from CPU 804 to signals which may drive video display 820. Computer 802 may further comprise one or more network interfaces. For example, communications network interface 814 may comprise a connection to an Internet Protocol (IP) communications network 822, which may transport user or control traffic. As a further example, communications network interface 814 may comprise a connection to a network or systems component or element (such as data processor 604 in FIG. 6). Computer 802 may further comprise AWG interface 816, through which CPU 804 may communicate with AWG 824 (corresponding to AWG 606 in FIG. 6). Computer 802 may further comprise network analyzer interface 818, through which CPU 804 may communicate with network analyzer 826 (corresponding to network analyzer 620 in FIG. 6). Computers are well known in the art and will not be described in detail herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for transmitting data through an optical network, comprising the steps of:
generating an arbitrary waveform based at least in part on a data bit stream; and
modulating an optical beam based at least in part on said arbitrary waveform to generate a first optical signal.

2. The method of claim 1, further comprising the step of:
transmitting said first optical signal through at least one optical element to generate at least one second optical signal;
wherein said step of generating an arbitrary waveform is further based at least in part on said at least one second optical signal.

3. The method of claim 2, wherein said at least one second optical signal comprises at least one dynamic feedback control signal.

4. The method of claim 3, further comprising the step of:
analyzing said at least one dynamic feedback control signal to generate at least one signal characteristic;
wherein said step of generating an arbitrary waveform is further based at least in part on said at least one signal characteristic.

5. The method of claim 2, wherein said at least one optical element comprises at least one wavelength multiplexer.

6. The method of claim 5, wherein said optical beam comprises at least one single wavelength laser beam.

7. The method of claim 2, wherein said at least one optical element comprises at least one wavelength demultiplexer.

8. The method of claim 7, wherein said optical beam comprises at least one single wavelength laser beam.

9. A apparatus for transmitting data through an optical network, comprising:
means for generating an arbitrary waveform based at least in part on a data bit stream; and
means for modulating an optical beam based at least in part on said arbitrary waveform to generate a first optical signal.

10. The apparatus of claim 9, further comprising:
means for transmitting said first optical signal through at least one optical element to generate at least one second optical signal.

11. The apparatus of claim 10, wherein said means for generating an arbitrary waveform further comprises means for generating an arbitrary waveform based at least in part on said at least one second optical signal.

12. The apparatus of claim 10, wherein said at least one second optical signal comprises at least one dynamic feedback control signal.

13. The apparatus of claim 12, further comprising:
means for analyzing said at least one dynamic feedback control signal to generate at least one signal characteristic.

14. The apparatus of claim 13, wherein said means for generating an arbitrary waveform further comprises means for generating an arbitrary waveform based at least in part on said at least one signal characteristic.

15. An apparatus for transmitting data through an optical network comprising:
an arbitrary waveform generator configured to:
receive control instructions, and
generate an arbitrary waveform based at least in part on said control instructions; and
a programming unit configured to:
receive a data bit stream, and
transmit control instructions to said arbitrary waveform generator, said control instructions based at least in part on said data bit stream.

16. The apparatus of claim 15, further comprising a RF driver module configured to:
receive said arbitrary waveform, and
transmit an RF signal to modulate an optical beam, said RF signal based at least in part on said arbitrary waveform.

17. The apparatus of claim 15, further comprising a network analyzer configured to:
receive at least one dynamic feedback control signal from said optical network, and
generate signal analysis data based at least in part on said at least one dynamic feedback control signal.

18. The apparatus of claim 17, wherein said signal analysis data is transmitted by said network analyzer to said programming unit.

19. The apparatus of claim 18, wherein said control instructions is further based at least in part on said signal analysis data.

20. A computer readable medium storing computer program instructions for transmitting data through an optical network, said computer program instructions defining the steps of:
receiving a data bit stream; and
transmitting control instructions to an arbitrary waveform generator, said control instructions based at least in part on said data bit stream

21. The computer readable media of claim 20, wherein said computer program instructions further comprise computer program instructions defining the step of:
receiving signal analysis data from a network analyzer, said signal analysis data representing at least one signal characteristic of at least one dynamic feedback control signal from said optical network.

22. The computer readable media of claim 21, wherein said computer program instructions further comprise computer program instructions defining the step of:
storing user-defined performance data.

23. The computer readable media of claim 22, wherein said computer program instructions further comprise computer program instructions defining the step of:
calculating a difference between said signal analysis data and said performance data, wherein said control instructions transmitted from said programming unit to said arbitrary waveform generator is based at least in part on said difference.
